(19) United States
(12) Patent Application Publication
(10) Pub. No.: US 2009/0128765 A1
(43) Pub. Date: May 21, 2009

(54) Display device

(75) Inventor: Won-Sang Park, Yongin-si (KR)

Correspondence Address: Haynes and Boone, LLP;IP Section, 2323 Victory Avenue, SUITE 700, Dallas, TX, 75219, US

(73) Assignee: Samsung Electronics Co., Ltd.

(21) Appl. No.: 12/012,665

(22) Filed: Feb. 4, 2008

(30) Foreign Application Priority Data
Nov. 16, 2007 (KR) 10-2007-0117423

(51) Int. Cl. G02F 1/1343; G02F 1/13

(52) U.S. Cl. 349/139; 349/187

(57) ABSTRACT

A display device may include a first substrate including a pixel region; a gate line disposed on the first substrate; a data line intersecting the gate line; a first electrode disposed on the data line; a second substrate facing the first substrate; a second electrode disposed on the second substrate, the second electrode including domain dividers, the domain dividers including a first domain divider having a first area S1 and a second domain divider having a second area S2 and the first area S1 being different from the second area S1; and a liquid crystal layer interposed between the first substrate and the second substrate, the liquid crystal layer including a first thickness D1 and a second thickness D2 in the pixel region and the first thickness D1 being different from the second thickness D2.

### CROSS-REFERENCE TO RELATED APPLICATION

This application claims priority to and the benefit of Korean Patent Application No. 10-2007-0117423 filed in the Korean Intellectual Property Office on Nov. 16, 2007, the entire contents of which are incorporated herein by reference.

### BACKGROUND

(a) Field of the Invention

The present invention relates to a display device to improve side visibility and display quality.

(b) Description of the Related Art

A liquid crystal display (LCD) is one of the most widely used flat panel displays. An LCD includes two substrates on which electrodes are formed and a liquid crystal layer that is interposed there between. When a voltage is applied to the electrodes, an electric field is generated and the liquid crystal molecules are re-arranged. The polarizers and liquid crystal molecules control the transmittance of the light to display images.

To achieve a wide viewing angle, a variety of liquid crystal modes have been developed.

In the vertical alignment mode (VA mode), when the voltage is not applied to the electrodes, the long axes of the liquid crystal molecules are vertically aligned to the substrate and a protrusion or aperture is formed on the electrode.

Also a mode having two types of linear electrodes formed on one substrate has been developed.

However, side visibility may be still distorted. So many methods have been developed to improve the side visibility.

### SUMMARY

The present invention relates to a display device, more precisely a display device to improve the side visibility and to improve display quality.

A transmissive type display device according to an embodiment of the present invention may include a pixel region, a first electrode in the pixel region, a second electrode facing the first electrode, domain dividers formed in the pixel region, the opening patterns including a first domain divider having a first area S1 and a second domain divider having a second area S2 and the first area S1 being different from the second area S2, and a liquid crystal layer interposed between the first electrode and the second electrode and the liquid crystal layer including a first thickness D1 and a second thickness D2 in the pixel region and the first thickness D1 being different from the second thickness D2.

A display device according to an embodiment of the present invention may include a first substrate having a pixel region, a first electrode disposed on the first substrate and the first electrode transmitting light to display one pixel image, a second substrate facing the first substrate, a second electrode disposed on the second substrate, domain dividers disposed on at least one of the first substrate and the second substrate, the domain dividers including a first domain divider having a first area S1 and a second domain divider having a second area S2 and the first area S1 being different from the second area S2, and a liquid crystal layer interposed between the first substrate and the second substrate, the liquid crystal layer including a first thickness D1 and a second thickness D2 in the pixel region and the first thickness D1 being different from the second thickness D2.

A transmissive type display device according to an embodiment of the present invention may include a first substrate having a pixel region, a gate line disposed on the first substrate, a data line intersecting the gate line, a first electrode disposed on the data line, a second substrate facing the first substrate, a second electrode disposed on the second substrate, the second electrode having domain dividers, the domain dividers including a first domain divider having a first area S1 and a second domain divider having a second area S2 and the first area S1 being different from the second area S1, and a liquid crystal layer interposed between the first substrate and the second substrate, the liquid crystal layer including a first thickness D1 and a second thickness D2 in the pixel region and the first thickness D1 being different from the second thickness D2.

A method for manufacturing a display device according to an embodiment of the present invention may include forming a first substrate including a pixel region, forming a first electrode on the first substrate and the first electrode transmitting light to display one pixel image, forming a second substrate facing the first substrate, forming a second electrode on the second substrate, forming domain dividers disposed on at least one of the first substrate and the second substrate, the domain dividers including a first domain divider having a first area S1 and a second domain divider having a second area S2 and the first area S1 being different from the second area S2, and forming a liquid crystal layer interposed between the first substrate and the second substrate, the liquid crystal layer including a first thickness D1 and a second thickness D2 in the pixel region and the first thickness D1 being different from the second thickness D2.

The scope of the invention is defined by the claims, which are incorporated into this section by reference. A more complete understanding of embodiments of the present invention will be afforded to those skilled in the art, as well as a realization of additional advantages thereof, through the following detailed description of one or more embodiments. Reference will be made to the appended sheets of drawings that will first be described briefly.

### BRIEF DESCRIPTION OF THE DRAWINGS

FIG. 1 is a cross-sectional view of the first embodiment of the present invention.

FIG. 2 is a plan view of the first embodiment of the present invention.

FIG. 3 is a cross-sectional view of the second embodiment of the present invention.

FIG. 4 is a plan view of the second embodiment of the present invention.

FIG. 5 is a graph of transmittance to gray with respect to viewing direction.

FIG. 6 is a graph of transmittance to gray with respect to the pixel portion.

FIG. 7 is a graph of transmittance to gray with respect to viewing direction.

FIG. 8 is a graph of voltage (V) to transmittance (T) with respect to thickness of the liquid crystal layer.

FIG. 9 is a cross-sectional view of the third embodiment of the present invention.

FIG. 10 is a cross-sectional view of the fourth embodiment of the present invention.

### DETAILED DESCRIPTION

Hereinafter, embodiments of the present invention will be described in detail with reference to the accompanying drawings so as to be easily understandable to those skilled in the art. As those skilled in the art will realize, the described embodiments may be modified in various ways, all without departing from the spirit or scope of the present invention.

To clarify multiple layers and regions, the thicknesses of the layers may be enlarged in the drawings. Like reference numerals designate like elements throughout the specification. When it is said that any part, such as a layer, film, area, or plate is positioned on another part, it means the part may be directly on the other part or above the other part with at least one intermediate part. On the other hand, if any part is said to be positioned directly on another part it means that there is no intermediate part between the two parts.

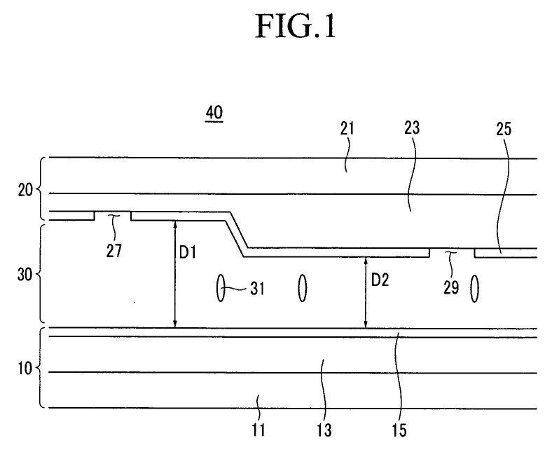

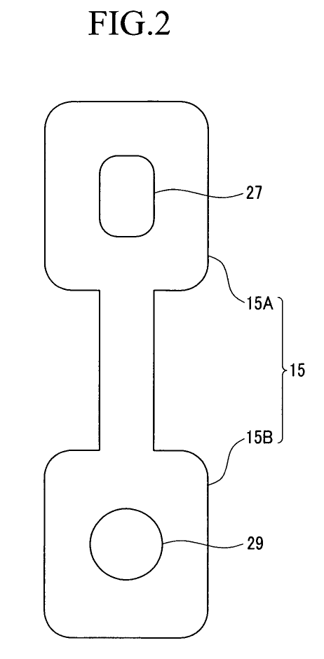

A display device of the first embodiment of the present invention will now be described in detail with reference to FIG. 1 and FIG. 2.

FIG. 1 is a cross-sectional view of the first embodiment of the present invention. FIG. 1 is a cross-section of a pixel region in which one pixel electrode is formed.

Referring to FIG. 1, a display device 40 includes the first display panel 10, the second display panel 20 and a liquid crystal layer 30. The liquid crystal layer 30 is interposed between the first display panel 10 and the second display panel 20.

The first display panel 10 includes the first substrate 11 and a pixel electrode 15 disposed on the first substrate 11. The second display panel 20 includes a second substrate 21, a color filter layer 23 and a common electrode 25. The color filter layer 23 is disposed on the second substrate 21. The color filter layer is formed to include an upper portion and a lower portion in the pixel region. The common electrode 25 includes the first opening pattern 27 and the second opening pattern 29.

The liquid crystal layer 30 includes liquid crystal molecules 31 having negative dielectric anisotropy. But the liquid crystal layer may also include liquid crystal molecules having positive dielectric anisotropy.

In one embodiment of the present invention, the thickness of the liquid crystal layer 30 includes a first thickness D1 and the second thickness D2 in the pixel region. The first thickness D1 is formed in a portion of pixel electrode 15 and the second thickness D2 is formed in the other portion of pixel electrode 15.

In one embodiment of the present invention, the first thickness D1 is 5.0 μm and the second thickness D2 is 3.4 μm. But there may be more variations in the thickness of the liquid crystal layer 30. The first thickness D1 can be formed between 4.0 μm to 5.5 μm and the second thickness D2 can be formed between 3.0 μm to 3.8 μm. The ratio between the first thickness D1 and the second thickness D2 can be from 1.1 to 1.8.

In one embodiment of the present invention, the pixel region includes a transmissive region, but the pixel region doesn't include the reflective region. That is to say, the pixel electrode 15 may be made of a transparent conducting material such as Indium-Tin-Oxide (ITO), Indium-Zinc-Oxide (IZO). However the pixel electrode 15 in some embodiments of the invention may not include another reflective electrode. So to display one pixel image, the pixel electrode 15 transmits light from the backlight in one pixel region.

FIG. 2 is a plan view of the first embodiment of the present invention. FIG. 2 is a plan view of the pixel region.

Referring to FIG. 2, the pixel electrode 15 includes a first portion 15A and a second portion 15B. The first portion 15A and the second portion 15B are electrically connected to each other.

In one embodiment of the present invention, the corners of the pixel electrode 15 are rounded off. In other words, the corners of the first portion 15A and the corners of the second portion 15B are rounded off. The shape of the first portion 15A maybe similar to the shape of the second portion 15B. For example, the shape of the first portion 15A may be a rounded rectangle and the shape of the second portion 15B may be a rounded rectangle.

The common electrode (not shown) is substantially formed on the whole surface of the second substrate (not shown). In one embodiment of the present invention, the common electrode includes the first opening pattern 27 and the second opening pattern 29 in the pixel region. The shape of the first opening pattern 27 and the shape of the second opening pattern 29 may be different from each other. The first opening pattern 27 is similar to a rounded rectangle and the second opening pattern 29 is similar to a circle. But there may be more variations in the shape of the opening patterns 27, 29.

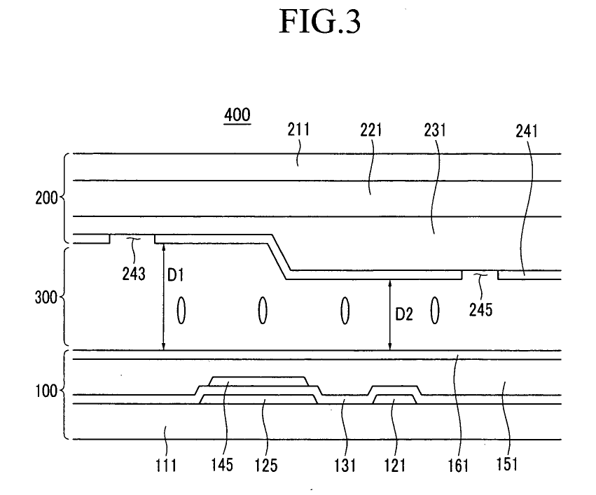

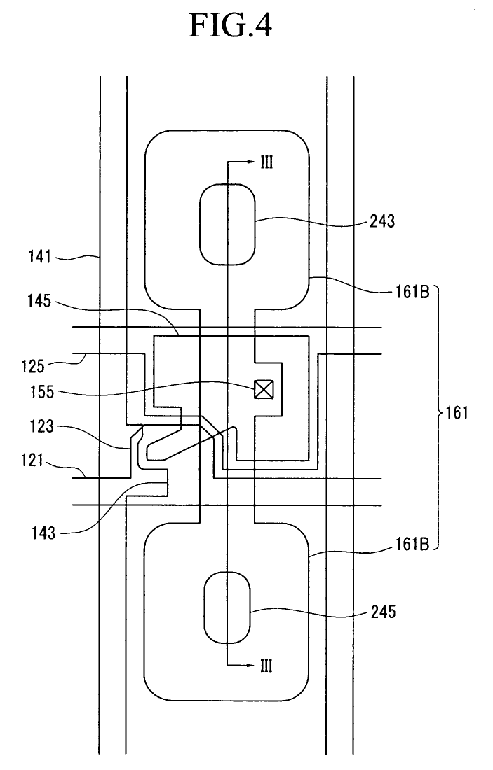

A display device of the second embodiment of the present invention will now be described in detail with reference to FIG. 3 and FIG. 4.

FIG. 3 is a cross-sectional view of the second embodiment of the present invention. FIG. 3 is a cross-section along III-III of FIG. 4.

Referring to FIG. 3, the thickness of the liquid crystal layer 300 includes a first thickness D1 and a second thickness D2 in the pixel region. The first thickness D1 may be 5.0 μm and the second thickness may be 3.4 μm. The first thickness D1 can be formed at a thickness of between 4.0 μm to 5.5 μm and the second thickness D2 can be formed at a thickness of between 3.0 μm to 3.8 μm. The ratio between the first thickness D1 and the second thickness D2 can be from 1.1 to 1.8.

In one embodiment of the present invention, a color filter layer 221 is disposed on the second substrate 211. An overcoating layer 231 is disposed on the color filter layer 221 and the overcoating layer 231 includes an organic material. To make the liquid crystal layer 300 having different thickness in the pixel region, the overcoating layer 231 is formed to have an upper portion and a lower portion in the pixel region. To make the liquid crystal layer 300 having different thickness, the color filter layer 221 may also be formed to have an upper portion and a lower portion.

Referring to FIG. 3, a gate line 121 including a gate electrode (not shown) is formed on the first substrate 111. In one embodiment of the present invention, a storage electrode line 125 may be formed on the same layer as the gate line 121. The gate line 121 and the storage line 125 may be formed as the same material.

The gate line 121 may be made of metal or a conductive material. For example, aluminum containing metals such as aluminum (Al) or aluminum alloy, silver containing metals such as silver (Ag) or silver alloy, copper containing metals such as copper (Cu) or copper alloy, molybdenum containing metals such as molybdenum (Mo) or molybdenum alloy, chromium (Cr), tantalum (Ta) and titanium (Ti) etc. The gate line 121 may also have a multilayered structure including two conductive layers (not shown).

A gate insulating layer 131 is formed on the gate line 121 and the storage line 125. The gate insulating layer 131 may be made of silicon nitride SiNx, silicon oxide SiOx, and so on.

A semiconductor (not shown) is formed on the gate insulating layer 131 and an ohmic contact layer (not shown) is formed on the semiconductor.

A data line (not shown), a source electrode (not shown) and a drain electrode 145 are formed on the gate insulating layer 131 and the ohmic contact layer (not shown).

The data line 141, the source electrode 143 and the drain electrode 145 may be made of metal or a conductive material. For example, aluminum containing metals such as aluminum (Al) or aluminum alloy, silver containing metals such as silver (Ag) or silver alloy, copper containing metals such as copper (Cu) or copper alloy, molybdenum containing metals such as molybdenum(Mo) or molybdenum alloy, chromium (Cr), tantalum (Ta) and titanium (Ti) etc. The data lines 141 may also have a multilayered structure, such as a double layer including molybdenum containing metal and aluminum containing metal and a triple layer including molybdenum containing metal, aluminum containing metal and molybdenum containing metal.

A passivation layer 151 is formed on the data line, the source electrode and the drain electrode 145. The passivation layer 151 may be made of inorganic material such as silicon nitride (SiNx), silicon oxide (SiOx) and so on. The passivation layer 151 may also be made of organic material such as acryl group material.

In one embodiment of the present invention, the passivation layer 151 includes the first layer including the inorganic material and the second layer including the organic material. The first layer can be formed on the data line, the source electrode and the drain electrode 145 and the second layer can be formed on the first layer.

A pixel electrode 161 is formed on the passivation layer 151. The pixel electrode 161 is electrically connected to the drain electrode 145 through a contact hole 155 of the passivation layer 151.

In one embodiment of the present invention, the pixel region includes a transmissive region, but the pixel region doesn't include a reflective region. That is to say, the pixel electrode 161 may be made of a transparent conducting material such as Indium-Tin-Oxide (ITO), Indium-Zinc-Oxide (IZO) but the pixel electrode 161 in one embodiment of the invention may not include another reflective electrode. So to display one pixel image, the pixel electrode 161 transmits light from in one pixel region.

FIG. 4 is a plan view of the second embodiment of the present invention.

Referring to FIG. 4, the pixel electrode 161 includes the first portion 161A and the second portion 161B. The first portion 161A and the second portion 161B are electrically connected to each other.

In one embodiment of the present invention the corners of the pixel electrode 161 are rounded off. In other words, the corners of the first portion 161A and the corners of the second portion 161B are rounded off. The shape of the first portion 161A may be similar to a rounded rectangle and the shape of the second portion 161B may be similar to a rounded rectangle. However, there may be more variations in the shape of the first portion 161A and the second portion 161B. The first portion 161A and the second portion 161B may be similar to a square.

The common electrode 241 includes a first opening pattern 243 and a second opening pattern 245. In one embodiment of the present invention, the first opening pattern 243 is formed in a region corresponding to the first portion 161A and the second opening pattern 245 is formed in a region corresponding to the second portion 161B. The first opening pattern 243 and the second opening pattern 245 are similar to a rounded rectangle, respectively.

The first opening pattern 243 has a first area S1 and the second opening pattern 245 has a second area S2. The first area S1 and the second area S2 are different from each other. The first area S1 may be 270 μm² and the second area S2 may be 225 μm². The ratio between the first area S1 and the second area S2 may be from 0.7 to 1.3.

Referring to FIG. 4, a data line 141 intersects a gate line 121 and the data line 141 includes a source electrode 143. A drain electrode 145 includes a protruding portion facing the source electrode 143. At least a part of the drain electrode 145 overlaps with the storage line 125.

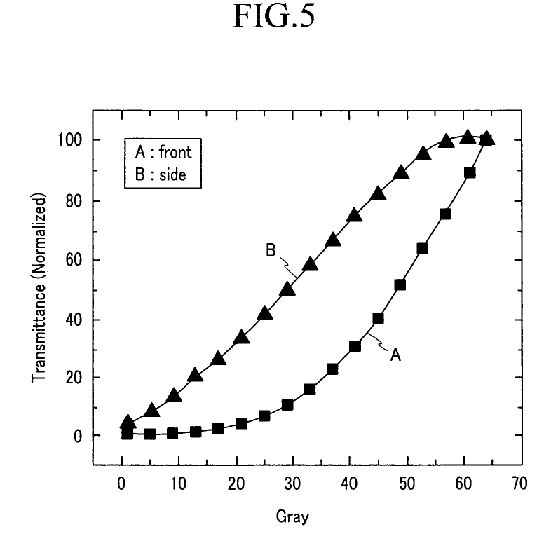

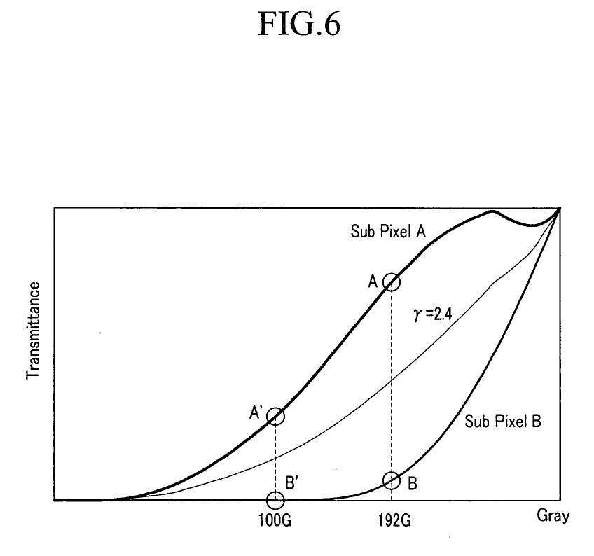

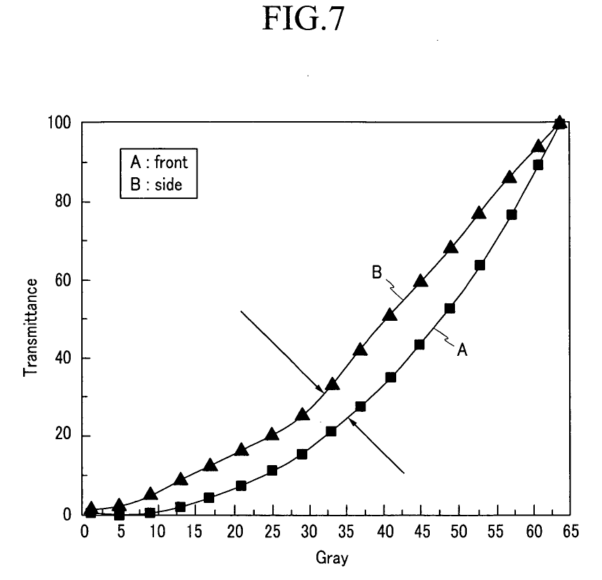

Now, the basic principle to improve side visibility will now be described in detail with reference to FIG. 5, FIG. 6 and FIG. 7.

FIG. 5 is a graph of transmittance to gray with respect to viewing direction on a normal liquid crystal display. The word gray means the degree of brightness of an image. In the liquid crystal display the gray can be formed as sixty four grays or one hundred twenty eight grays. In a normal black mode (without electric field to show dark state), the gray level is roughly proportional to the voltage.

In FIG. 5, graph A shows the transmittance of the gray from a front view and graph B shows the transmittance of the gray from a side view. According to FIG. 5, the curve of the side view is distorted in comparison with the curve of the front view. It means that the side visibility is distorted. In general, the set up is based on the transmittance of the gray based on the front view.

FIG. 6 is a graph of transmittance to gray with respect to the pixel portion, when the pixel electrode is divided into two portions, such as sub pixel A and sub pixel B, and the two portions have a different transmittance in the pixel region. In FIG. 6, graph A shows the transmittance to the gray of sub pixel A, and graph B shows the transmittance to the gray of sub pixel B.

FIG. 7 is a graph of transmittance to gray with respect to viewing direction, when the pixel electrode is divided into two portions and the two portions have a transmittance as shown in FIG. 6. In FIG. 7, graph A shows the transmittance to the gray for a front view, and graph B shows a transmittance to the gray for a side view. According to FIG. 7, the curve of the side view is very similar to the curve of the front view. So when the two regions which are shown the different transmittance each other are formed in the pixel region, the side visibility can be improved.

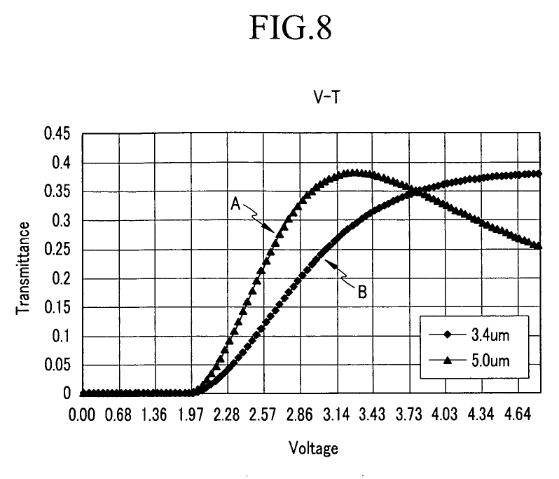

The principle to improve the side visibility of one embodiment of the present invention will now be described in detail with reference to FIG. 8.

FIG. 8 is a graph of voltage (V) to transmittance (T) with respect to thickness of the liquid crystal layer. In FIG. 8, graph A represents a liquid crystal layer having a thickness of 5.0 μm and graph B represents a liquid crystal layer having a thickness of 3.4 μm.

Referring to FIG. 8, a curve of voltage (V) to transmittance (T) is shifted with respect to the thickness of the liquid crystal layer. The transmittance on higher thickness A and the transmittance on lower thickness B may be different from each other at the same voltage.

According to FIG. 8, when two regions have liquid crystal layers of different thicknesses, each of the regions is formed in the pixel region. The transmittance of each region can be different from each other in the pixel region. Thus side visibility can be improved.

As in the preceding, when the opening patterns of the common electrode are formed to have a different area or have a different shape in the pixel region, the transmittance of each region can be different from each other. So the side visibility also can be improved.

When the different thickness of liquid crystal layer and the different area of opening patterns are formed in the pixel region at once, we can finely control the transmittance at each portion of the pixel region to improve the side visibility.

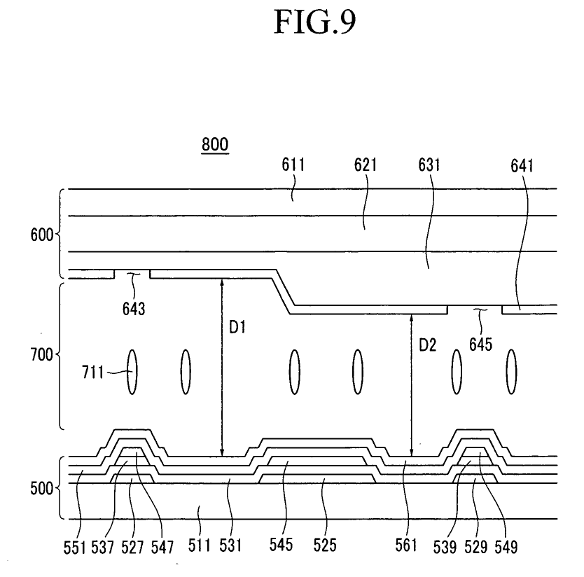

A display device of the third embodiment of the present invention will now be described in detail with reference to FIG. 9.

FIG. 9 is a cross-sectional view of the third embodiment of the present invention.

Referring to FIG. 9, the first stack 527, 537, 547 and the second stack 529, 539, 549 are formed on the first substrate 511. The first stack 527, 537, 547 is formed in the region corresponding to the first opening pattern 643 and the second stack 529, 539, 549 is formed in the region corresponding to the second opening pattern 645.

The first stack 527, 537, 547 includes the first metal portion 527, a semiconductor portion 537 and the second metal portion 547. The first metal portion 527 is formed on the same layer as the gate line (not shown) and the storage line 525 and the first metal portion 527 may be made of the same material as the gate line. The semiconductor portion 537 is formed on the same layer as the semiconductor (not shown) and the semiconductor portion 537 may be made of the same material as the semiconductor. The second metal portion 547 is formed on the same layer as the data line (not shown), the drain electrode 545 and the second portion 547 may be made of the same material as the data line and the drain electrode 545.

The second stack 529, 539, 549 includes the first metal portion 529, a semiconductor portion 539 and the second metal portion 549. The first metal portion 529 is also formed on the same layer as the gate line. The semiconductor portion 539 is formed on the same layer as the semiconductor. The second metal portion 549 is formed on the same layer as the data line.

The liquid crystal layer 700 includes the first thickness D1 and the second thickness D2 and the first thickness D1 is thicker than the second thickness D2. In one embodiment of the present invention, the first thickness D1 is 4.9 μm and the second thickness is 3.5 μm. The first thickness D1 can be formed from 4.0 μm to 5.5 μm, and the second thickness D2 can be formed from 3.0 μm to 3.8 μm. The ratio between the first thickness D1 and the second thickness D2 can be from 1.1 to 1.8.

The common electrode 645 includes the first opening pattern 643 and the second opening pattern 645. The first opening pattern 643 has the first area S1 and the second opening pattern 645 has the second area S2. The first area S1 is smaller than the second area S2. In one embodiment of the present invention, the first area S1 is 225 μm² and the second area S2 is 270 μm². The ratio between the first area and the second area may be from 0.7 to 1.3.

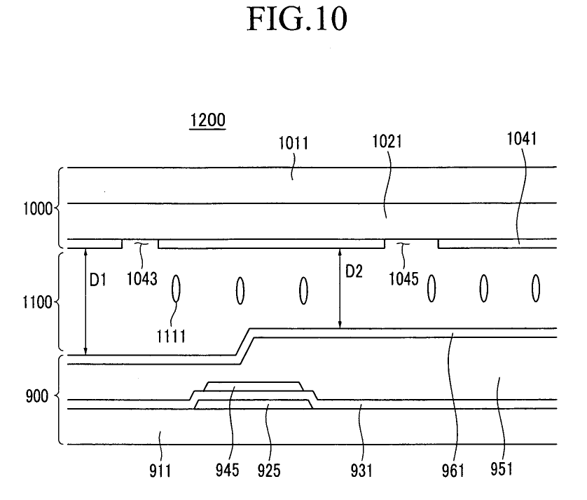

A display device of the fourth embodiment of the present invention will now be described in detail with reference to FIG. 10.

FIG. 10 is a cross-sectional view of the fourth embodiment of the present invention.

Referring to FIG. 10, the passivation layer 951 includes an organic material. To vary the thickness of liquid crystal layer 1100, the passivation layer 951 is formed to have different thicknesses in the pixel region. That is to say, the passivation layer 951 is formed to have an upper portion and a lower portion in the pixel region. The passivation layer 951 may be formed as two layers which include the first layer being made of an inorganic material and the second layer being made of an organic material. The first layer may be formed to have a uniform thickness and the second layer may be formed to have different thickness in the pixel region.

The liquid crystal layer 1100 is formed to include the first thickness D1 and the second thickness D2 in the pixel region and the first thickness D1 is thicker than the second thickness D2. In one embodiment of the present invention, the first thickness D1 is 4.8 μm and the second thickness is 3.6 μm. The first thickness D1 can be formed from 4.0 μm to 5.5 μm and the second thickness D2 can be formed from 3.0 μm to 3.8 μm and the ratio between the first thickness D1 and the second thickness D2 can be from 1.1 to 1.8.

The common electrode 1041 includes the first opening pattern 1043 and the second opening pattern 1045. The first opening pattern 1043 has a first area S1 and the second opening pattern 1045 has a second area S2. The first area S1 is larger than the second area S2. The first area S1 may be 270 μm² and the second area S2 may be 270 μm². The ratio between the first area S1 and the second area S2 may be from 0.7 to 1.3.

As described above, the side visibility of the display device may be improved and the display quality may also be improved.

While embodiments of the present invention have been described in detail above, it will be understood by those skilled in the art that various changes in form and details may be made therein without departing from the spirit and scope of the present invention. For example, although the present invention was described above based on four processes, the present invention can be used for three processes. Accordingly, the scope of the invention is defined only by the following appended claims.

What is claimed is:

1. A transmissive type display device, comprising:
a pixel region;
a first electrode in the pixel region;
a second electrode facing the first electrode;
domain dividers formed in the pixel region, the domain dividers comprising a first domain divider having a first area S1 and a second domain divider having a second area S2 and the first area S1 being different from the second area S2; and
a liquid crystal layer interposed between the first electrode and the second electrode and the liquid crystal layer comprising a first thickness D1 and a second thickness D2 in the pixel region and the first thickness D1 being different from the second thickness D2.

2. The transmissive type display device of claim 1, wherein the first electrode comprises:
a first opening pattern corresponding to the first area S1; and
a second opening pattern corresponding to the second area S2.

3. The transmissive type display device of claim 1, wherein the first electrode comprises a first portion and a second portion electrically connected to the first portion.

4. The transmissive type display device of claim 3, wherein a shape of the first portion is substantially similar to a shape of the second portion.

5. The transmissive type display device of claim 1, wherein the first thickness D1 is formed between from 3.0 μm to 3.8 μm and the second thickness D2 is formed between from 4.0 μm to 5.5 μm.

6. The transmissive type display device of claim 5, wherein a ratio between the first area S1 and the second area S2 is from 0.7 to 1.3.

7. A display device, comprising:
a first substrate comprising a pixel region;
a first electrode disposed on the first substrate and the first electrode transmitting light to display one pixel image;
a second substrate facing the first substrate;
a second electrode disposed on the second substrate;
domain dividers disposed on at least one of the first substrate and the second substrate, the domain dividers comprising a first domain divider having a first area S1 and a second domain divider having a second area S2 and the first area S1 being different from the second area S2; and
a liquid crystal layer interposed between the first substrate and the second substrate, the liquid crystal layer comprising a first thickness D1 and a second thickness D2 in the pixel region and the first thickness D1 being different from the second thickness D2.

8. The display device of claim 7, wherein the domain dividers are opening patterns.

9. The display device of claim 8, wherein the opening patterns are formed in the first electrode.

10. The display device of claim 7, wherein the first domain divider and the second domain divider are disposed in the pixel region.

11. The display device of claim 8, wherein the first thickness D1 is formed between from 3.0 μm to 3.8 μm and the second thickness D2 is formed between from 4.0 μm to 5.5 μm.

12. The display device of claim 11, wherein a ratio between the first area S1 and the second thickness S2 is from 0.7 to 1.3.

13. A transmissive type display device, comprising:
a first substrate comprising a pixel region;
a gate line disposed on the first substrate;
a data line intersecting the gate line;
a first electrode disposed on the data line;
a second substrate facing the first substrate;
a second electrode disposed on the second substrate, the second electrode comprising domain dividers, the domain dividers comprising a first domain divider having a first area S1 and a second domain divider having a second area S2 and the first area S1 being different from the second area S1; and
a liquid crystal layer interposed between the first substrate and the second substrate, the liquid crystal layer comprising a first thickness D1 and a second thickness D2 in the pixel region and the first thickness D1 being different from the second thickness D2.

14. The transmissive type display device of claim 13, wherein the domain dividers are opening patterns.

15. The transmissive type display device of claim 13, comprising a layer disposed on the second substrate and the layer comprising an upper portion and a lower portion in the pixel region.

16. The transmissive type display device of claim 15, wherein the layer comprises a color filter layer.

17. The transmissive type display device of claim 13, wherein the first domain divider and the second domain divider are disposed in the pixel region.

18. The transmissive type display device of claim 13, comprising a first stack and a second stack disposed on the first substrate.

19. The display device of claim 18, wherein the first stack is corresponded to the first domain divider and the second stack is corresponded to the second domain divider.

20. The display device of claim 19, wherein the first stack comprises a first metal.

21. The display device of claim 18, wherein the first domain divider is a first opening pattern and the second domain divider is a second opening pattern.

22. A method for manufacturing a display device, comprising:
forming a first substrate comprising a pixel region;
forming a first electrode on the first substrate and the first electrode transmitting light to display one pixel image;
forming a second substrate facing the first substrate;
forming a second electrode on the second substrate;
forming domain dividers disposed on at least one of the first substrate and the second substrate, the domain dividers comprising a first domain divider having a first area S1 and a second domain divider having a second area S2 and the first area S1 being different from the second area S2; and
forming a liquid crystal layer interposed between the first substrate and the second substrate, the liquid crystal layer comprising a first thickness D1 and a second thickness D2 in the pixel region and the first thickness D1 being different from the second thickness D2.

23. The method of claim 22, wherein the domain dividers are opening patterns.

24. The method of claim 23, wherein the opening patterns are formed in the first electrode.

25. The method of claim 22, wherein the first thickness D1 is formed between from 3.0 μm to 3.8 μm and the second thickness D2 is formed between from 4.0 μm to 5.5 μm.
